(19) United States
(12) Patent Application Publication
(10) Pub. No.: US 2024/0007325 A1
(43) Pub. Date: Jan. 4, 2024

(54) METHOD FOR DETERMINING COMPONENTS OF A SENSOR NETWORK WITHIN AN IN-VEHICLE ETHERNET NETWORK IN A MOTOR VEHICLE

(71) Applicant: Continental Automotive Technologies GmbH, Hannover (DE)

(72) Inventor: Helge Zinner, Regensburg (DE)

(73) Assignee: Continental Automotive Technologies GmbH, Hannover (DE)

(21) Appl. No.: 18/255,508

(22) PCT Filed: Dec. 1, 2021
(86) PCT No.: PCT/DE2021/200229

§ 371 Date: Jun. 1, 2023

(30) Foreign Application Priority Data
Dec. 1, 2020 (DE) 10 2020 215 086.9

(51) Int. Cl. H04L 12/40

(52) U.S. Cl. CPC H04L 12/40006; H04L 2012/40273

(57) ABSTRACT

A method for determining components of a sensor network within an Ethernet on-board network in a motor vehicle between at least two ECU nodes and at least one further ECU node. The at least one ECU node responds to a received payload with a payload only after a delay time, the delay time satisfying the condition t_{BUS}≥t_{B}+(t_{P}+t_{C}) n, where t_{B} denotes a beacon time of the ECU node, t_{C} denotes the commit time of the further ECU node, t_{P} denotes the maximum payload with the maximum length, and n denotes the number of ECU nodes.

### CROSS REFERENCE TO RELATED APPLICATIONS

The present application is a National Stage Application under 35 U.S.C. § 371 of International Patent Application No. PCT/DE2021/200229 filed on Dec. 1, 2021, and claims priority from German Patent Application No. 10 2020 215 086.9 filed on Dec. 1, 2020, in the German Patent and Trademark Office, the disclosures of which are herein incorporated by reference in their entireties.

### TECHNICAL FIELD

The present invention relates to a method for determining components of a sensor network within an Ethernet on-board network in a motor vehicle, to a control device and to an Ethernet on-board network.

### BACKGROUND

With 10 Mbit/s (IEEE802.3ch), in addition to 100 Mbit/s; 1000 Mbit/s and the ongoing multi-gigabit standardizations, another Ethernet standard will be available for automotive applications.

The new standard differs significantly from the other variants since its aim is to be able to make Ethernet more cost-effective and thus also to address simpler control devices. This standard does not require any switches (switch ICs), but rather is designed as a bus, similarly to CAN. This roughly halves the number of required PHYs (transceivers). Ethernet is thus becoming a serious alternative to CAN/CAN-FD and FlexRay, as it is able to significantly reduce system costs.

FIG. 1 compares features of switched Ethernet and “Bus Ethernet” (called MultiDrop). The most important difference here is that the resources (the bus access) are available exclusively with switched Ethernet, which means that any Ethernet node (ECU) is able to transmit at any time without collisions occurring in the process. The new Ethernet bus implementation uses a shared medium and it is necessary to wait for bus access until the resources become available.

The PIEEE802.3cg standard uses a newly defined mechanism (PLCA Physical Layer Collision Avoidance) to avoid collisions during bus access and to grant fair access. In this case, only exactly one PHY (transceiver) ever receives access to the bus at exactly one time. This makes it possible to avoid collisions. Access is based on what is called a round-robin method. Each ECU (node) on the bus has the opportunity to transmit within a defined cycle. A so-called head node in this case determines the cycle and transmits one “beacon” on the bus per cycle. The nodes, depending on their previously allocated ID (determines the order when they are allowed to transmit), thus start a timer, and are allowed to transmit after the timer has expired.

DE 19710971 A1 describes a method for determining the propagation time of a telegram between two participants in a bus system, wherein a first participant transmits a telegram to a second participant and, after transmitting the telegram, starts a time measuring apparatus, wherein the second participant transmits a response telegram to the first participant immediately after receiving the telegram and wherein the first participant stops the time measuring apparatus when the response telegram arrives and calculates the propagation time of a telegram from the measured time.

DE 19947657 A1 discloses an operating method for a data bus for multiple participants with flexible time-controlled access, characterized by the following features: the participants are synchronized, the bus telegrams are sent in a hierarchical transmission order by the participants and, at least in part, only as required, a switching element is located between the participants and the data bus and enables bus access for the respective participant only and for as long as the participant is allowed to transmit.

EP 1473864 A1 discloses a method for transmitting data telegrams between at least two radio devices (A, B) and at least one repeater (R), wherein at least one radio device (A, B) responds to a received data telegram (request telegram) with a data telegram (response telegram) only after a delay time.

### SUMMARY

In contrast to a switched network (as with 100,1000, etc. Mbit/s), with 10 Mbit/s, as described, the bus cannot be accessed immediately, but rather it is necessary to wait for the respective time. Only the head node (master node that controls the bus) knows the entire bus and the connected nodes (ECUs and sensors). The respective node itself does not know how many nodes are connected to the bus. In other words, it (and this applies to all nodes) does not know how long the maximum delay will last until it or others are allowed to transmit (again). This information is helpful because the technology is also currently being planned in critical fields such as ADAS, for example.

The Ethernet MAC and the above software layers have no information whatsoever about possible and future transmission windows. This causes higher costs in terms of ECU design and planning of the already very complicated communication in the on-board electrical system.

Modern approaches are not yet sufficiently optimized with regard to the possibilities of the dynamic use of software. The planning of communication (for example sensor data streams) is essential for the high-precision execution of actions based on sensor data. If no transmission delays or bus access times are specified, then this leads to higher costs in the planning of such systems—reuse for other platforms is also greatly restricted, which in turn further increases our implementation costs.

In partially automated and highly automated driving, there are increasing demands on the vehicle that require hard real-time support from the transmission network and the protocols (as is already the case at present in aircraft or industrial automation). Time synchronization is playing an important role in this. The more accurate the time, the better the related functions, such as for example sensor fusion. An on-board electrical system will also be much more flexible in the future than it is today. Nodes are deactivated during operation when they are not needed (this is also called partial networking). This in turn means that the on-board electrical system will change dynamically to a very large degree at runtime. These functions are already being implemented and mass-produced for 2020.

The object of the present disclosure is to specify a solution for dealing, in a motor vehicle network, with variable communication partners involved in the communication.

The object is advantageously addressed by the method for determining components of a sensor network within an Ethernet on-board network in a motor vehicle having the features of claim 1, the control device as claimed in claim 5, the Ethernet on-board network as claimed in claim 5, the computer program product as claimed in claim 8, the computer-readable medium as claimed in claim 9 and the vehicle as claimed in claim 10.

One advantageous embodiment of the method for determining components of a sensor network within an Ethernet on-board network in a motor vehicle, between at least two ECU nodes (ECU A, ECU B) and at least one further ECU node (ECU C), wherein at least one ECU node (ECU A, ECU B) responds to a received payload (P1) with a payload (P2) only after a delay time, the delay time (t_{BUS}) satisfies the condition t_{BUS}≥t_{B}+(t_{P}+t_{C}) n, where t_{B} denotes a beacon time of the ECU node (A, B), where t_{C} denotes the commit time of the further ECU node (C), where t_{P} denotes the maximum payload with the maximum length and where n denotes the number of ECU nodes (A, B, C), is distinguished in that an ECU node (ECU A, ECU B) of the Ethernet on-board network calculates the time length of an unused cycle (Z₀), in which no payload (P1, P2) should be sent, using a transmit opportunity timer (TOT), and following calculation of the pure cycle length (T_{L}), which is ascertained by transmitting the beacon time at the time t_{B}, the transmission window of an ECU node (ECU A, ECU B, ECU C) is used to calculate the number of nodes n that are located in the Ethernet on-board network.

One advantageous embodiment of the method according to the present disclosure is distinguished in that the beginning of a new cycle (Z₀) is identified, the start time of cycle +1 (Z₁) is sought, it being checked whether a payload (P1, P2) was transmitted between the new cycle (Z₀) and the cycle (Z₁) and, in the event of a transmission, the cycle (Z₁) is set to the cycle (Z₀), and the cycle length T_{L} is calculated dynamically.

One particularly advantageous embodiment of the method is distinguished in that the number of nodes n of the ECU nodes (ECU A, ECU B) located in the Ethernet on-board network is formed by the ratio of the cycle length (T_{L}) to the value of the transmit opportunity timer (TOT), wherein, beforehand, the transmit opportunity timer (TOT) is queried in order to form the ratio of the cycle length (T_{L}) to the value of the transmit opportunity timer (TOT).

Particularly advantageously, the object is achieved by a control unit for an Ethernet on-board network, which, as a first ECU node, is designed, as a control unit, to transmit a signal to a second control unit of the Ethernet on-board network and to receive the signal from the second control unit; to determine a propagation time of the signal on a connection path to the second control unit; to determine a maximum speed of the connection path based on the propagation time; and to determine a type of a transmission medium of the connection path based on the maximum speed, at least comprising a microprocessor, a volatile memory and non-volatile memory, at least two communication interfaces, a synchronizable timer, the non-volatile memory containing program instructions that, when executed by the microprocessor, wherein at least one embodiment of the method according to the present disclosure is able to be implemented and executed.

A further advantageous embodiment of the Ethernet on-board network for a motor vehicle, having a first control unit and a second control unit, is distinguished in that the control units are connected to one another via at least one connection path, and at least the first control unit is designed to carry out the method according to the present disclosure.

A further advantageous embodiment of the Ethernet on-board network is distinguished in that the Ethernet on-board network has a third control unit, which is connected to the first control unit only indirectly and is connected to the second control unit directly by way of a third connection path, wherein the third control unit is designed to determine a propagation time of a third signal on the third connection path, wherein the first control unit is designed to trigger the determination of the propagation time of the third signal by way of a service message to the third control unit.

The quality of the execution of software-based applications (for example, automated driving, data loggers, diagnostics, 5G) may advantageously be increased by the present disclosure, in particular without additional financial outlay. The use of the newly introduced Ethernet protocol in automobiles necessitates mechanisms that make use of simple techniques and given properties of technologies in order to be able to do without expensive implementations and further additional hardware. The network system according to the present disclosure is improved in terms of costs and reliability. Using software-based methods, a supplier is thereby able to get the best out of its ECU or the network and offer its customers more functionality.

The Ethernet technologies are advantageously improved by the present disclosure in terms of costs and implementation effort for use in the automotive sector.

The advantage of the application-specific determination of a more accurate and predictable delay is an improvement in the scheduling and execution of communication in the vehicle. This means that existing bus systems are able to be used better and the jump to expensive technology (bandwidth) is able to be avoided. This may also affect otherwise required buffer storage, which may then be dispensed with (or made smaller). Fusions of different data (for example, camera+radar) may thus be improved and made more accurate. Furthermore, the logging of data may be made even more precise.

Nowadays, applications are sold, tailored and adapted to an OEM or exactly one project. This present disclosure sets forth methods that allow software development to be made more flexible and make the best of the underlying system without having to program it permanently into software beforehand. The present disclosure permits software developers and software architects to offer software/applications that may be tailored to the requirements of the application case more flexibly and precisely. Incorporating the cited methods into software allows optimization to take place in each case specifically. This means that software platforms may be implemented more independently.

In future architectures, a specific application is no longer necessarily linked to a specific control device, but rather may also be executed by different control devices. If an application is moved, it is necessary to create the appropriate environment for the new scenario as well, for example at least the same clock synchronization quality.

The new technologies must no longer be held up in motor vehicles. Protocols such as IP, AVB and TSN have thousands of pages of specifications and test suites. It is not an immediate given that these new protocols are controllable in the automotive sector. One advantage of this present disclosure is that the usual hardware does not have to be changed, but rather the existing hardware may continue to be used. The new method may be integrated into an existing network without damaging existing devices. The standard is not infringed since the existing protocol may be used.

Modern vehicle networks are configured statically, that is to say the data communication (transmitter, receiver and data relationship) is fixed at the latest when the vehicle is programmed at the end of the line. The upcoming architectures and the desire for service-oriented communication contradict the current approach and require new concepts. For the next generations after motor vehicle networks, it will not always be clear who the recipient of the data is and which way the data will go. Each recipient may therefore have different requirements in terms of data transmission, for example external ECU is in a cloud solution, or it is an unprotected ECU. It is therefore necessary to dynamically address the requirements of the recipient and potentially adapt the data transmission mechanisms. The present disclosure advantageously identifies that, if the transmission time is able to be predicted, more precise data may be used, which increases the quality of the sensor data and the fusion thereof.

### BRIEF DESCRIPTION OF THE DRAWINGS

An example embodiment of the present disclosure is depicted in the drawings and will be described in greater detail below. In the drawings:

FIG. 1 shows a simplified representation of the differences between an Ethernet bus (10 Mbit/s) and a switched network (all other automotive variants such as for example 100 Mbit/s);

FIG. 2 shows a general method for dynamically calculating the maximum delay in the sensor network;

FIG. 3 shows calculation of the cycle length; and

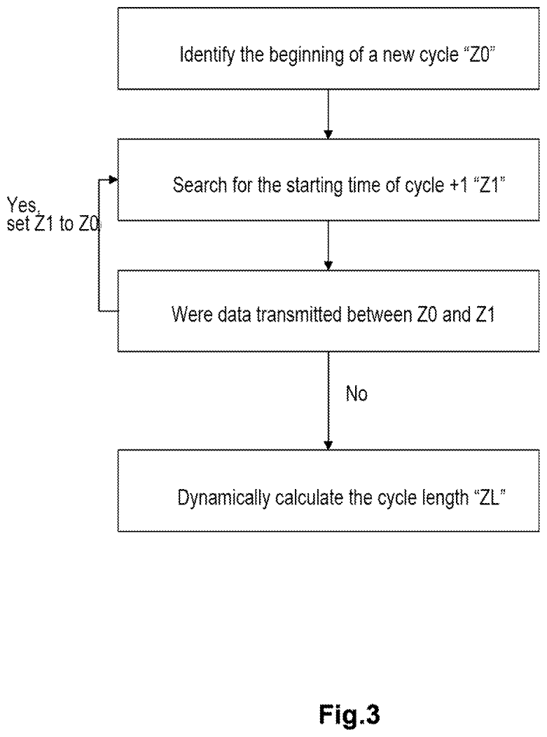

FIG. 4 shows calculation of the number of participants on the bus.

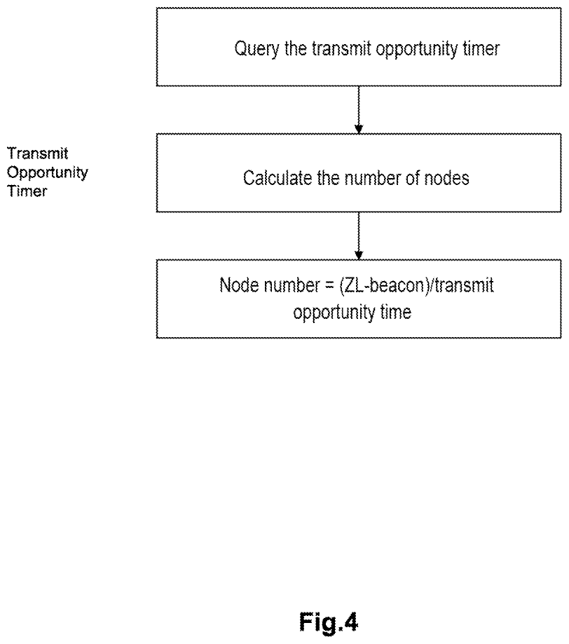

### DETAILED DESCRIPTION

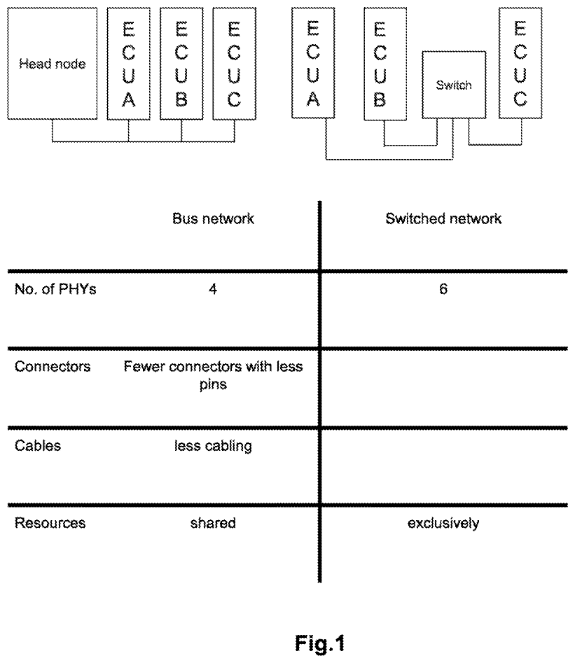

FIG. 1 shows, in simplified form, the differences between an Ethernet bus (10 Mbit/s) and a switched network, which occur in a motor vehicle environment with all other automotive variants such as, for example, 100 Mbit/s and symbolically represent the ECU nodes ECU-A, ECU-B, ECU-C.

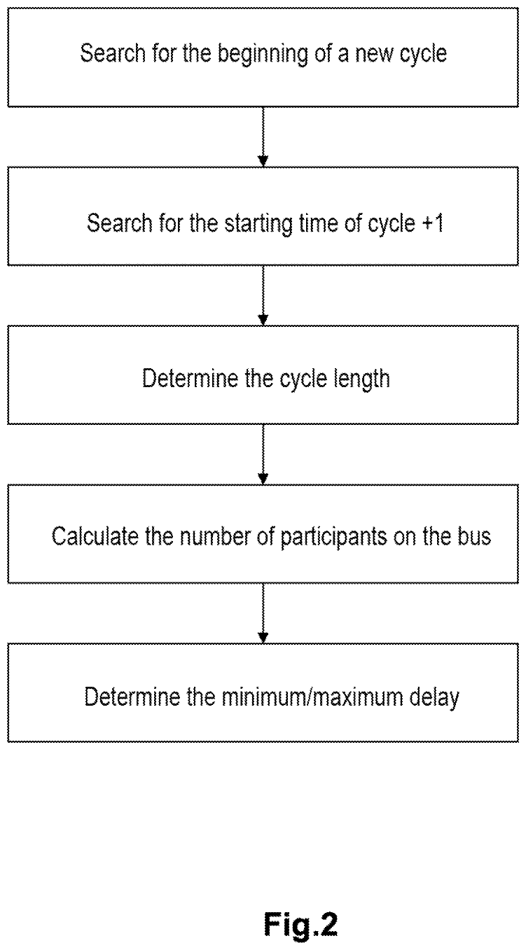

FIG. 2 represents the general solution to the problem described above. In this case, a node (ECU) of the bus, other than the head node, measures the time length of an unused cycle, in which no payload data are allowed to be sent. This may be repeated and verified as often as desired. Following determination of the pure cycle length T_{L}, which may be recognized by the transmission of a so-called beacon, the transmission window of an ECU node (ECU A, ECU B, ECU C) may be used to calculate how many participants are on the bus. Finally, the minimum and maximum delay during bus access may thereby be ascertained dynamically, without this being preconfigured.

The present disclosure proposes a method for determining the minimum and maximum bus access time. Following sending of the beacon, a timer starts and is only interrupted if other data are received.

If no data, payload is received from other ECU nodes (ECU A, ECU B, ECU C) until the next beacon, then the cycle length may be calculated. This mechanism may and should be repeated dynamically in order to identify dynamic changes in the network or in the Ethernet on-board network or to avoid measurement errors.

Following receipt of a so-called beacon, the 1st ECU node (ID=0) has typically 20 bit times to send data. If it does not do this within this time, the ECU node with the next highest ID is allowed to transmit, etc. Timers are started at all nodes n so that these know the earliest time at which they are allowed to start transmitting. The Transmit_Opportunity is configured identically for all nodes and may be read locally from the application software by the ECU node (network stack). Using the cycle length T_{L}, it may then be calculated for the first time how many nodes n, that is to say ECUs, are connected to the network or Ethernet on-board network. In other words, it is thus possible to calculate how many nodes are allowed to transmit before me and how many are allowed to transmit after me.

If for example 140 bits is assumed as the cycle length and the Transmit_Opportunity is 20 bits, then it is possible to calculate, independently on each node, that exactly 7 nodes are connected to the Ethernet on-board network or bus.

With knowledge of the number of connected ECUs, the minimum and maximum bus access time may be calculated deterministically again depending on the ID (position on the bus).

The minimum bus access time is calculated from the beacon time, commit time and the maximum Ethernet payload*number of nodes that have a smaller ID.

The next bus access time (from the time at which I transmitted, that is to say when can I transmit again) is calculated from the total number of nodes*(maximum payload+commit time)+beacon time.

Since each ECU node has a timer, or recognizes this when the beacon is sent, the ECU node, using this method, is able for the first time to calculate, at any time, when it is allowed to transmit again. In the same way, it is possible to ascertain when all other ECU nodes are also allowed to transmit again and when it is necessary to adopt a setting for receiving data.

Each ECU node (ECU A, ECU B, ECU C) knows its own ID, which also determines its position on the bus, but no node knows how many nodes are connected to the bus after it. This new finding may be highly useful when scheduling communication, for example when it comes to designing buffer memories. Furthermore, the information is helpful to check whether the data (sensor data) are still valid or whether for instance new data are already available before the node has the opportunity to transmit again.

1. A method for determining components of a sensor network within an Ethernet on-board network in a motor vehicle between at least two ECU nodes and at least one further ECU node, wherein at least one ECU node responds to a received payload with a payload only after a delay time, the delay time satisfies a condition t_{BUS}≥t_{B}+(t_{P}+t_{C}) n, where t_{B} denotes a beacon time of the ECU node, t_{C} denotes a commit time of the further ECU node, t_{P} denotes a maximum payload with a maximum length, and n denotes a number of ECU nodes, wherein an ECU node of a bus of the Ethernet on-board network, other than a head node, measures a time length of an unused cycle in which no payload data were sent, with the time length measuring being repeated and verified, and following determination of a pure cycle length T_{L}, which is recognized by transmission of a beacon, a transmission window of an ECU node is used to calculate a number of nodes on the bus, wherein minimum and maximum delays during bus access are ascertained dynamically, without being preconfigured.

2. The method as claimed in claim 1, wherein the ECU node of the Ethernet on-board network calculates the time length of an unused cycle, in which no payload were sent, using a transmit opportunity timer, and following calculation of the pure cycle length, which is ascertained by transmitting the beacon at the time t_{B}, the transmission window of the ECU node is used to calculate the number of nodes n that are located in the Ethernet on-board network.

3. The method as claimed in claim 1, further comprising
identifying a beginning of a new cycle,
seeking a start time of a second cycle following the new cycle,
checking whether a payload was transmitted between the new cycle and the second cycle and, in the event of a transmission, the second cycle is set to the new cycle, and
dynamically calculating the cycle length T_{L}.

4. The method as claimed in claim 1, wherein the number of nodes n of the ECU nodes located in the Ethernet on-board network is formed by a ratio of the cycle length to a value of a transmit opportunity timer, wherein, beforehand, the transmit opportunity timer is queried in order to form the ratio of the cycle length to the value of the transmit opportunity timer.

5. A control unit for an Ethernet on-board network, which, as a first ECU node,
is configured, as a control unit:
to transmit a signal to a second control unit of the Ethernet on-board network and to receive the signal from the second control unit;
to determine a propagation time of the signal on a connection path to the second control unit;
to determine a maximum speed of the connection path based on the propagation time; and
to determine a type of a transmission medium of the connection path based on the maximum speed,
wherein the control unit comprises:
a microprocessor,
a volatile memory and non-volatile memory,
at least two communication interfaces, and
a synchronizable timer,
wherein the non-volatile memory contains program instructions that, when executed by the microprocessor, cause the microprocessor to perform the method as claimed in claim 1.

6. An Ethernet on-board network for a motor vehicle, having a first control unit and
a second control unit, wherein the control units are connected to one another via at least one connection path, and at least the first control unit is configured as claimed in claim 5.

7. The Ethernet on-board network as claimed in claim 6, wherein
the Ethernet on-board network has a third control unit, which is connected to the first control unit only indirectly and is connected to the second control unit directly by way of a third connection path, wherein the third control unit is configured to determine a propagation time of a third signal on the third connection path, and the first control unit is configured to trigger the determination of the propagation time of the third signal by a service message to the third control unit.

8. A computer program product comprising commands that, when the computer program product is executed by a computer, causes the said computer to perform the method as claimed in claim 1.

9. A non-transitory computer-readable medium on which the computer program product as claimed in claim 7 is stored.

10. A vehicle having an Ethernet on-board network comprising multiple control units, each control unit performing as claimed in claim 5.
